(19) United States
(12) Patent Application Publication
(10) Pub. No.: US 2017/0366855 A1
(43) Pub. Date: Dec. 21, 2017

(54) MOBILE TERMINAL FOR PROVIDING VIDEO MEDIA, SYSTEM INCLUDING THE SAME, AND METHOD FOR CONTROLLING THE SAME

(71) Applicant: LEE, Ki Sung, Jeonju-si (KR)

(72) Inventor: Ki Sung LEE, Jeonju-si (KR)

(21) Appl. No.: 15/345,768

(22) Filed: Nov. 8, 2016

(30) Foreign Application Priority Data
Jun. 17, 2016 (KR) 10-2016-0075558

(51) Int. Cl. H04N 21/472; G06F 3/0488; H04N 21/482; H04N 21/485

(52) U.S. Cl. CPC H04N 21/47202; H04N 21/4852; G06F 3/0488; H04N 21/4825

(57) ABSTRACT

Provided is a control method of a mobile terminal. The control method includes a first step of storing, by a storing unit, at least one video medium; a second step of reproducing, by a control unit, an arbitrary video medium among at least one video medium which is previously selected from the stored video media to output the video media on an entire screen before the mobile terminal enters an initial screen by switching an inactive state to an active state and providing an interface for receiving a user command for entering the initial screen; and a third step of entering, by the control unit, the initial screen in accordance with the user command.

### CROSS-REFERENCE TO RELATED APPLICATIONS

This application is based on and claims priority from Korean Patent Application No. 10-2016-0075558, filed on Jun. 17, 2016, with the Korean Intellectual Property Office, the disclosure of which is incorporated herein in its entirety by reference.

### TECHNICAL FIELD

The present disclosure relates to a mobile terminal for providing a video media, a system including the same, and a method for controlling the same. More particularly, the present disclosure relates to a mobile terminal for providing a video media mounted with a video media player which is driven first when an inactive state of the mobile terminal is switched to an active state, a system including the same, and a method for controlling the same.

### BACKGROUND

A terminal may be classified into a mobile terminal (or a portable terminal) and a stationary terminal depending on whether to be carried.

Among these, as a function of the mobile terminal is diversified, for example, the mobile terminal is implemented as a multimedia player having complex functions such as a function of taking a picture or a video, a function of reproducing a music or a video file, or a function of receiving a game or broadcasting.

According to a recent report, 90% or more users operate a mobile terminal as one of behavior patterns which is performed as soon as they get up in the morning.

That is, the users experience, share, and learn various worlds by consuming various contents through a mobile terminal so that it can be said that the users live in different worlds from the reality. The users place a high value on a reality which is valued more than addiction.

The users set a photo of the most precious person as a background screen of the mobile terminal or keep the photo to achieve an emotional stability. Further, the users seek their own spatial values with various stories with family, a lover, friends, celebrities, daily life, travels, and the like which are melted in the photo. This is because the users see the photo anytime and remember and recall the past any time.

In this tendency, recently, new techniques which stimulate emotions of the users whenever the users operate the mobile terminal to increase the satisfaction of the users rapidly appear.

For example, even though a technique which reproduces a video set by a user in an initial screen of the mobile terminal to output the video on the screen appears, most of the video screen which is reproduced in accordance with this method is blocked by a program icon so that the user may not pay attention to the video. Further, since the video player is always driven on the background of the initial screen, some of system resources need to be assigned to the video player all the time, which may affect driving of various programs which operate on the initial screen.

### SUMMARY

The present disclosure has been made in an effort to provide a mobile terminal which provides a video media by a new method which reproduces a previously stored video media when an inactive state of the mobile terminal is switched to an active state to output the video media on the entire screen without manipulating to reproduce the video which the user wants to play, a system including the same, and a method for controlling the same, thereby increasing satisfaction of a user for consumption of contents.

An exemplary embodiment of the present disclosure provides a control method of a mobile terminal. The control method includes: a first step of storing, by a storing unit, at least one video medium; a second step of reproducing, by a control unit, an arbitrary video medium among at least one video medium which is previously selected from the stored video media to output the video media on an entire screen before the mobile terminal enters an initial screen by switching an inactive state to an active state and providing an interface for receiving a user command for entering the initial screen; and a third step of entering, by the control unit, the initial screen in accordance with the user command.

The initial screen may be a lock screen which includes an interface for receiving an unlock input or a background screen which includes an interface for receiving a program executing command stored in the storing unit.

The user command for entering the initial screen may be performed by a touch input on any one area of the screen, and in the second step, an interface for receiving an input to suppress entering the initial screen by the touch input on any one area of the screen may be provided.

In the second step, an interface for receiving a selection input for a video medium which is currently reproduced, from the at least one previously selected video media list or at least one video media list stored in the storing unit without entering the initial screen may be provided.

The control method may further include downloading, by the control unit, at least one video medium selected from the video media list which is provided by a video media providing server; and storing the downloaded video medium in the storing unit.

In the downloading, an arbitrary advertisement in an advertisement list which is provided from an advertisement providing server may be output on the screen during the downloading.

The control method may further include: uploading, by the control unit, the video media selected by the user, among the video media stored in the storing unit to the video media providing server.

In the uploading, an arbitrary advertisement in an advertisement list which is provided from an advertisement providing server may be output on the screen during the uploading.

The control method may further include storing, by the storing unit, previously set weekly video media reproducing lists. In the second step, an arbitrary video medium in a video media reproducing list corresponding to a present day of the week among the weekly video media reproducing lists may be reproduced to be output on a screen.

The control method may further include: receiving information on at least one video medium to be transmitted, a terminal of an opposite party to which the at least one video medium is transmitted, and a time to transmit the at least one video medium, from the user; transmitting the information on the terminal of the opposite party to transmit, the time to transmit, and the video media to be transmitted to a time capsule server; transmitting, by the time capsule server, an alarm signal to the terminal of the opposite party when it is the time to transmit; and transmitting, by the time capsule server, the at least one video medium to the terminal of the opposite party in accordance with a request received from the terminal of the opposite party.

The storing unit may include a first storing unit which stores the at least one video medium; and a second storing unit which stores at least one sound medium, and the method may further include: providing, by the control unit, an interface for receiving an volume adjusting input for the video medium of the first storing unit and the sound medium of the second storing unit, respectively, selected by the user; and combining the video medium of the first storing unit and the sound medium of the second storing unit with the volume determined in accordance with the volume adjusting input.

The control method may further include determining whether a present time is a previously set alarm time; and reproducing an arbitrary video medium among at least one previously set video medium when the present time is the previously set alarm time, to be output on the entire screen.

Another exemplary embodiment of the present disclosure provides a mobile terminal for providing a video medium. The mobile terminal includes a storing unit which stores at least one video medium; and a control unit which reproduces an arbitrary video medium among at least one video medium which is previously selected from the stored video media to output the video medium on an entire screen before the mobile terminal enters an initial screen by switching an inactive state to an active state and provides an interface for receiving a user command for entering the initial screen.

Still another exemplary embodiment of the present disclosure provides a system for providing video media. The system includes the mobile terminal and a video media providing server which transmits video media to the mobile terminal or receives the video media from the mobile terminal to store the video media.

Yet another exemplary embodiment of the present disclosure provides a computer readable recording medium which records a computer program to execute the control method of the mobile terminal.

According to the exemplary embodiments of the present disclosure, the inactive state of the mobile terminal is switched to an active state so that the video player is driven before a lock screen or a background screen appears to reproduce the video media on the entire screen. Therefore, the user does not need to manipulate a storage device file searching program in order to access the video media. That is, the user may watch a desired video media without performing a separate manipulation.

Further, since a video medium which is stored or selected in accordance with an intention of the user is reproduced, there is no worry to be exposed to reckless advertisements. Further, there is no limitation of expense for a mobile communication network used when a streaming video media is reproduced.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE DRAWINGS

FIG. 1 is a diagram illustrating a configuration of a mobile terminal according to an exemplary embodiment of the present disclosure.

FIG. 2 is a flowchart of steps of a control method of a mobile terminal according to an exemplary embodiment of the present disclosure.

FIG. 3 is a diagram illustrating a configuration of a system including a mobile terminal according to an exemplary embodiment of the present disclosure.

FIGS. 4A to 4C are exemplary views for explaining a process of downloading a video media by a mobile terminal which accesses a video media providing server according to an exemplary embodiment of the present disclosure.

FIG. 5 is an exemplary view of a screen which uploads a video media stored in a mobile terminal to a video media providing server according to an exemplary embodiment of the present disclosure.

FIG. 6 is an exemplary view of a screen on which a video media is reproduced to be output according to an exemplary embodiment of the present disclosure.

FIGS. 7A and 7B are exemplary views of an interface provided when a video media is reproduced according to an exemplary embodiment of the present disclosure.

FIG. 8 is an exemplary view of a screen on which a weekly video media reproducing list is set according to an exemplary embodiment of the present disclosure.

FIGS. 9A and 9B are exemplary views of a screen using a time capsule server according to an exemplary embodiment of the present disclosure.

FIG. 10 is an exemplary view of an interface screen which edits a video media according to an exemplary embodiment of the present disclosure.

### DETAILED DESCRIPTION OF THE INVENTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Exemplary embodiments of the present disclosure will be described in detail with reference to the accompanying drawings. In describing the present disclosure, when it is determined that a detailed description of related well-known technology may obscure the gist of the present invention, the detailed description thereof will be omitted. Accordingly, the drawings and description are to be regarded as illustrative in nature and not restrictive. Like reference numerals designate like elements throughout the specification. In addition, in the specification, unless explicitly described to the contrary, the word “comprise” and variations such as “comprises” or “comprising”, will be understood to imply the inclusion of stated elements but not the exclusion of any other elements.

### Mobile Terminal

The mobile terminal of the present disclosure includes a portable phone, a smart phone, a laptop computer, a digital broadcasting terminal, a personal digital assistant (PDA), a portable multimedia player (PMP), a navigation, a slate PC, a tablet PC, an ultra-book, and a wearable device.

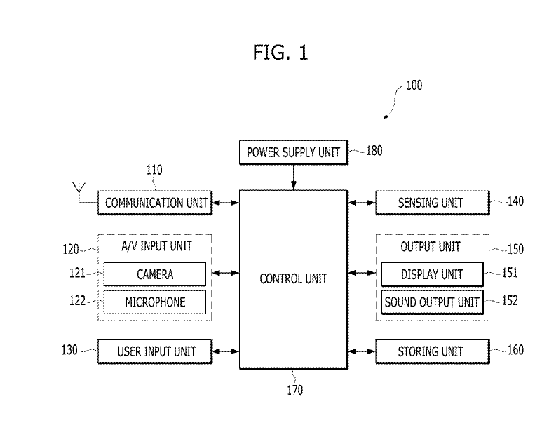

FIG. 1 is a diagram illustrating a configuration of a mobile terminal according to an exemplary embodiment of the present disclosure.

A mobile terminal 100 may include a wireless communication unit 110, an AV (audio/video) input unit 120, a user input unit 130, a sensing unit 140, an output unit 150, a storing unit 160, a control unit 170, and a power supply unit 180. Since the constituent elements illustrated in FIG. 1 are not necessary, a mobile terminal may be implemented to have more constituent elements or less constituent elements.

Hereinafter, the constituent elements will be described in sequence.

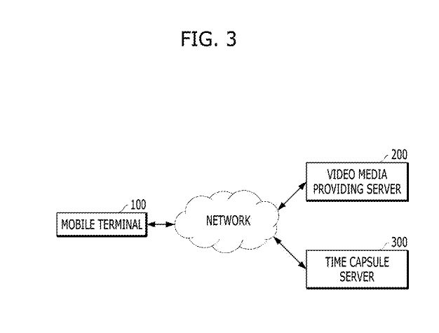

The communication unit 110 connects the mobile terminal 100 with various networks to communicate with each other so that the mobile terminal 100 may transmit and receive data to and from various types of remote terminals or servers through at least one network. Therefore, the mobile terminal 100 according to the exemplary embodiment of the present disclosure may transmit and receive various data to and from a video media providing server 200 or a time capsule server 300, as illustrated in FIG. 3.

The communication unit 110 may be inwardly or externally provided in the mobile terminal 100. The communication unit 110 may be a wireless internet module or a mobile communication module such as a wireless LAN (WLAN), a wireless fidelity (WiFi) direct, a digital living network alliance (DLNA), a wireless broadband (Wibro), a world interoperability for microwave access (Wimax), or a high speed downlink packet access (HSDPA). Further, the communication unit 110 may be a short range communication module such as a Bluetooth, radio frequency identification (RFID), infrared data association (IrDA), ultra-wideband (UWB), ZigBee, or near field communication (NFC).

The mobile communication module may transmit or receive a wireless signal to or from at least one of a base station, an external terminal, a client, and a server in a mobile communication network which is built in accordance with technical standards for mobile communication or a communication scheme. Here, the wireless signal may include an audio call signal, a video call signal, or various types of data (or information) in accordance with transmission/reception of a text/multimedia message.

The wireless internet module indicates a module for wireless internet connection and may be configured to transmit or receive a wireless signal in a communication network in accordance with wireless internet techniques. From a viewpoint in that the wireless internet connection is performed through a mobile communication network, the wireless internet module which performs the wireless internet connection through the mobile communication network may be understood as a kind of mobile communication module.

The A/V input unit 120 is provided to input an audio signal or a video signal and the A/V input unit 120 may include a camera 121 and a microphone 122.

The camera 121 processes an image frame which is obtained through an image sensor in a video call mode, a photographing mode, or the like, to display a still image, a video, or the like, on a display unit 151 or store the still image, the video, or the like, in the storing unit 160.

The microphone 122 receives an external sound signal through a microphone in a call mode, a recording mode, a voice recognizing mode, a photographing mode, or the like, to convert the external sound signal into electrical voice data. In this case, the mobile terminal 100 may include hardware or software in which various noise removal algorithms are implemented to remove a noise which may be generated during a process of receiving the external sound signal through the microphone 122.

The user input unit 130 receives various commands applied from a user and generates input data corresponding to the commands. The user input unit 130 may be configured by a keypad, a dome switch, a touch pad (static pressure/static electricity), a jog wheel, a jog switch, or the like.

The sensing unit 140 detects a current status of the mobile terminal 100 such as an open/closed status of the mobile terminal 100, a position of the mobile terminal 100, contact of the user, an orientation of the mobile terminal, and acceleration/deceleration of the mobile terminal and generates a sensing signal in accordance with the status. For example, when the mobile terminal 100 is a slide phone type, the sensing unit 140 may detect whether a slide phone is open or closed or whether the power is supplied through the power supply unit 180.

The output unit 150 is provided to generate an output related with a sense of sight, a sense of hearing, or a sense of touch and includes a display unit 151 and a sound output module 152.

The display unit 151 may output information processed in the mobile terminal 100 on a screen. For example, when the mobile terminal 100 is in a photographing mode, the display unit 151 displays a photographed and/or received image, a related UI, or the like. When a video media is reproduced, the display unit 151 may display a reproduced image and/or a related UI.

The display unit 151 may include at least one of a liquid crystal display (LCD), a thin film transistor liquid crystal display (TFT LCD), an organic light emitting diode (OLED), a flexible display, and a 3D display, and an e-ink display.

Two or more display units 151 may be provided depending on an implementation type of the mobile terminal 100. For example, a plurality of display units may be disposed on one surface to be spaced apart from each other or to be integrated or may be disposed on different surfaces, respectively.

In the meantime, when the display unit 151 and a sensor (hereinafter, referred to as a “touch sensor”) which detects a touch operation form a layered structure (hereinafter, referred to as a “touch screen”), the display unit 151 may also be used not only as an output device but also as an input device. The touch sensor may have a type such as a touch film, a touch sheet, and a touch pad.

The touch sensor is configured to convert a change of a pressure which is applied to a specific part of the display unit 151 or a capacity which is generated in a specific part of the display unit 151 into an electrical input signal. The touch sensor may be configured to detect not only a position and an area of a touch subject which is touched on the touch sensor but also a pressure when the touch subject is touched. Here, the touch subject is an object which applies the touch onto the touch sensor. For example, the touch subject may be a finger, a touch pen, a stylus pen, or a pointer.

When there is a touch input onto the touch sensor, a corresponding signal is transmitted to a touch controller. The touch controller processes the signal and then transmits the corresponding data to the control unit 170. By doing this, the control unit 170 recognizes which area of the display unit 151 is touched.

The sound output module 153 may output audio data which is received from the wireless communication unit 110 in a call signal receiving mode, a call mode, a recording mode, a voice recognizing mode, or a broadcasting receiving mode or stored in the storing unit 160. The sound output module 153 may output a sound signal related with various functions (for example, an alarm signal for receiving a call signal, receiving a message, or the like) which are performed in the mobile terminal 100. The sound output module 153 may include a receiver, a speaker, and a buzzer.

The storing unit 160 may store at least one program for an operation of the control unit 170 or store data (for example, a video media, a sound media, or the like) which is input or output in accordance with the program.

The storing unit 160 may include at least one type of storing medium of a flash memory type, a hard disk type, a multimedia card micro type, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The mobile terminal 100 may operate in association with a web storage which performs a storage function of the storing unit 160 on the Internet.

The control unit 170 is a unit which controls an overall operation of the mobile terminal 100 and performs various operations or processes various information.

In association with this, the control unit 170 according to the exemplary embodiment of the present disclosure may control or drive various programs (for example, a video media player, a camera photographing program, or the like) stored in the storing unit 160 and use various data stored in the storing unit 160.

Specific description thereof will be made when a control method of a mobile terminal is described.

In the meantime, the power supply unit 180 is applied with an external power or an internal power in accordance with the control of the control unit 170 to supply power required for operations of the components of the mobile terminal 100.

Hereinafter, a specific exemplary embodiment of a mobile terminal for providing a video media according to the present disclosure and a control method thereof will be described.

### Control Method of Mobile Terminal

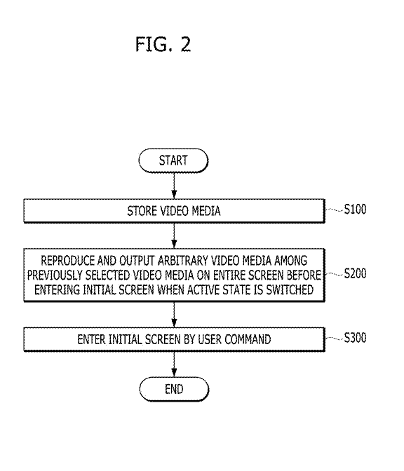

FIG. 2 is a flowchart of steps of a method for controlling a mobile terminal according to an exemplary embodiment of the present disclosure.

As illustrated in FIG. 2, a control method of a mobile terminal according to an exemplary embodiment of the present disclosure includes a first step S100 of storing, by the storing unit 160, at least one video medium, a second step S200 of reproducing, by a control unit 170, an arbitrary video medium among at least one previously selected video media to output the video media on an entire screen, before the mobile terminal 100 enters an initial screen by switching an inactive state of the mobile terminal into an active state and providing an interface for receiving a user command for entering the initial screen, and a third step S300 of entering, by the control unit 170, an initial screen in accordance with the user command.

However, since the steps illustrated in FIG. 2 are not necessary, a control method of a mobile terminal may be implemented to have more steps or less steps.

Hereinafter, the steps will be described in sequence.

In the first step S100, the storing unit 160 stores a video medium. The video media may be stored by being downloaded from a video media providing server 200 (see FIG. 3) or stored by being photographed through the A/V input unit 120.

Specifically, according to an exemplary embodiment, the video media including image information and voice information obtained through the camera 121 and the microphone 122 may be stored in the storing unit 160. According to another exemplary embodiment, the mobile terminal 100 which is connected to the video media providing server 200 to communicate with each other stores the video media which are downloaded from the video media providing server 200 in the storing unit 160.

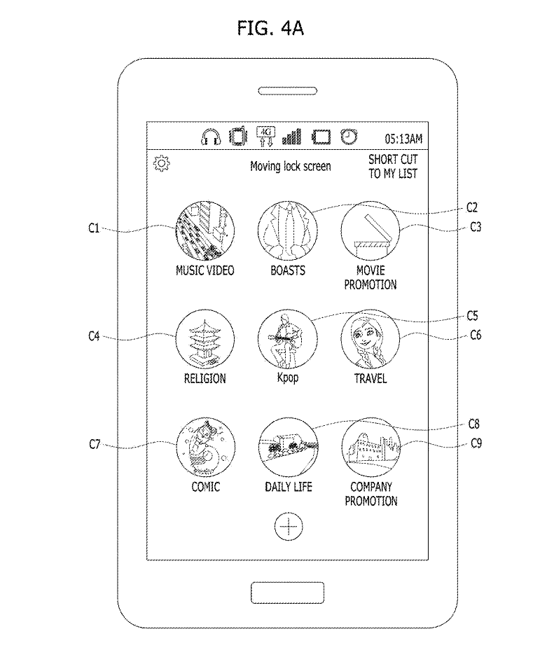

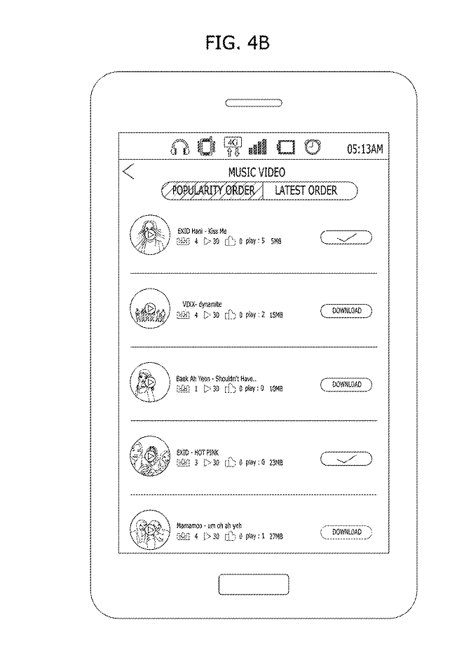

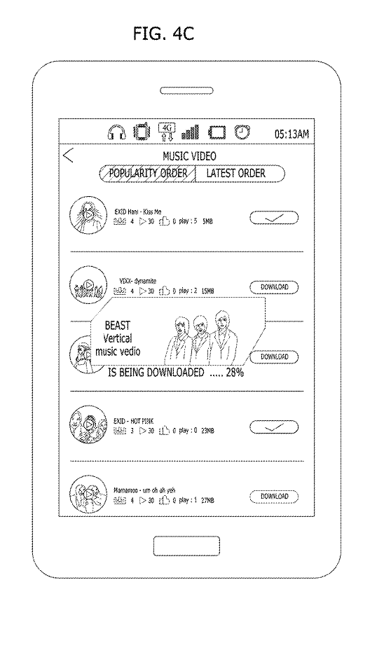

FIGS. 4A and 4B are exemplary views for explaining a process of downloading a video medium by a mobile terminal which accesses a video media providing server according to an exemplary embodiment of the present disclosure.

FIG. 4A illustrates an example of a screen connected to the video media providing server 200. As illustrated in FIG. 4A, in order to allow the mobile terminal 100 to receive selection of a video medium to be downloaded from the user, the video media providing server 200 classifies video media to be provided to the user for every category and provides a category list to the user through the mobile terminal 100. For example, the mobile terminal 100 which is connected to the video media providing server 200 outputs a category list, which is classified into a music video C1, boasts C2, movie promotion C3, religion C4, K-pop C5, travel C6, comic C7, daily life C8, company promotion C9, and the like, on a screen to provide the category list to the user. The present disclosure does not specifically limit category classification criteria of the video media.

In this case, when the mobile terminal 100 receives a selection input for any one category from the user, the video media providing server 200 transmits a low level category list included in the category to the mobile terminal 100 or transmits a video media list included in the selected category to the mobile terminal 100 to output the video media list on the screen. For example, as illustrated in FIG. 4B, when there is a selection input for a music video C1 category from the user, the mobile terminal 100 enumerates the video media lists included in the category to be output on the screen. Here, as the video media lists, not only a title of the video media, but also information such as a number of times of being downloaded by the user, a number of times of being recommended by the user, a reproducing time, or a media file capacity may be provided to the user. Here, the information which is provided to the user may be obtained from statistics of information collected from several users by the video media providing server 200 or extracted from attribute information of a video media file stored in the video media providing server 200.

In the meantime, the mobile terminal 100 may receive a command for enumerating the video media lists from the user. Accordingly, the mobile terminal 100 enumerates the video media lists in accordance with a popularity order (based on the number of times being downloaded by the user or the number of times being recommended by the user) or a latest order (based on a time stored in the video media providing server 200) to output the video media lists on the screen.

When the mobile terminal 100 receives a selection input for at least one of the video media lists output on the screen, the mobile terminal 100 transmits a download request for the at least one selected video media to the video media providing server 200. The video media providing server 200 transmits the video media file to the mobile terminal 100 in accordance with the download request so that the mobile terminal 100 downloads the video media file to be stored in the storing unit 160.

In this case, during the downloading process, the mobile terminal 100 may output advertisement (or a video advertisement or a banner image) on the screen, as illustrated in FIG. 4C. That is, the advertisement is inserted in a part of the screen on which the video media list transmitted from the video media providing server 200 is displayed to be output. However, this may cause repulsion of the users. Further, when the advertisement is exposed during the downloading process, boredom of the users which may be caused during the downloading process may be resolved. Here, the advertisement which is output by the mobile terminal 100 may be provided by an advertisement providing server (not illustrated) or the video media providing server 200 in accordance with the download request which is input from the user.

In the meantime, according to the exemplary embodiment of the present disclosure, the user may upload at least one video medium selected from the video media stored in the storing unit 160 to the video media providing server 200. In this case, the video media to be uploaded may be a video medium which is downloaded from the video media providing server 200, a video medium obtained through the AN input unit 120 or a video medium obtained by editing the video medium. However, a type of the video media is not specifically limited thereto.

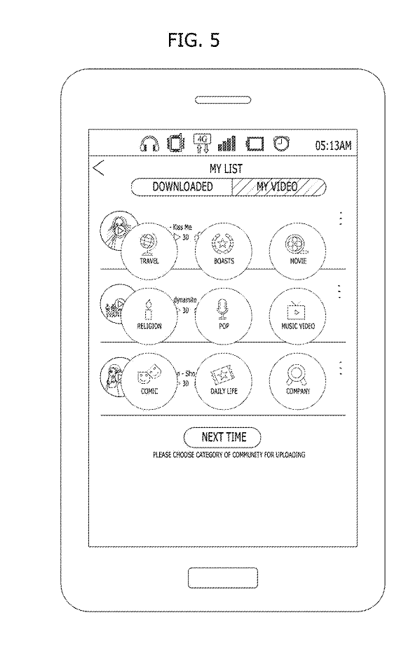

When the user uploads the video media to the video media providing server 200 through the mobile terminal 100, as illustrated in FIG. 5, a category to be uploaded is selected to upload the video media to the category or a new category is created to upload the video media to the newly created category.

Similarly, during an uploading process, the mobile terminal 100 desirably outputs the advertisement (or the video advertisement or the banner image) on the screen. That is, the advertisement is inserted in a part of the screen on which the video media list stored in the storing unit 160 is displayed to be output to the video media providing server 200. However, this may cause repulsion of the users. Further, when the advertisement is exposed during the uploading process, boredom of the users which may be caused during the uploading process may be resolved. Here, the advertisement which is output by the mobile terminal 100 may be provided by an advertisement providing server (not illustrated) or the video media providing server 200 in accordance with the download request which is input from the user.

The users which are connected to the video media providing server 200 share the video media, through the video media which are uploaded from the user as described above so that the users may communicate with each other by means of the video media.

Here, according to the exemplary embodiment of the present disclosure, when the user uploads a specific video media to the video media providing server 200, a lock code such as a password may be set to the specific video media or a specific category to be uploaded. Therefore, the video media providing server 200 transmits the video media such that the video media is downloaded only when a corresponding unlock code is input or provides a video media list included in the specific category. Therefore, the specific video media may be suppressed from being indiscriminately exposed to a plurality of anonymous users.

In the second step S200, before the mobile terminal 100 enters the initial screen by switching the inactive state of the mobile terminal 100 into the active state, an arbitrary video medium among at least one video medium previously selected from the video media stored in the storing unit 160 is reproduced to be output on the entire screen. Further, an interface for receiving an initial screen entering command from the user may be provided. Further, the third step S300 is a process for entering the initial screen in accordance with the command when the initial screen entering command from the user is input.

Here, the initial screen is a first screen generated when the inactive state of the mobile terminal 100 is switched to the active state. Generally, the initial screen is a screen generated when the inactive state is switched to the active state by pressing a physical button, for example, a power button or a home button, by the user. For example, the initial screen may represent a lock screen for receiving an unlock input (a password input or a pattern input) from the user or a background screen on which program icons for receiving a program executing command stored in the mobile terminal 100 are enumerated.

Here, the video media is not a still image or an image with a “gif” format which sequentially outputs a plurality of still images, but a video including a sound and an image such as “avi” or “mp4” format.

Specifically, in the second step S200, the control unit 170 or the sensing unit 140 detects that a screen of the terminal is turned on. When it is detected that the screen of the terminal is turned on, the control unit 170 reproduces one of the selected video media by playing a video player to output the video media on the screen before outputting the initial screen on the screen. In this case, even though the mobile terminal 100 is rebooted, the control unit 170 may repeat the above operations.

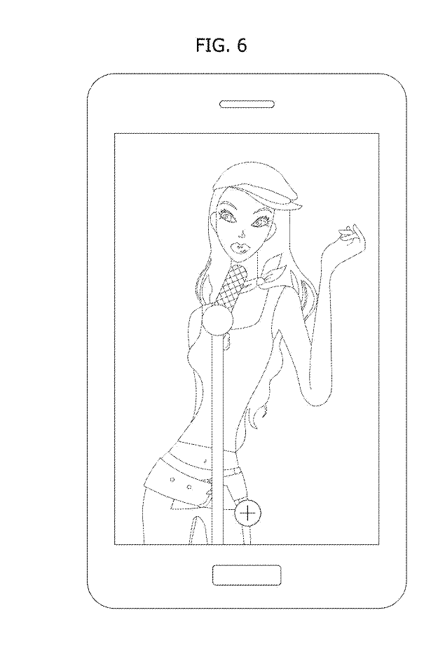

During the second step S200, as illustrated in FIG. 6, the mobile terminal 100 plays the video player first before entering the initial screen so that the at least one video medium selected by the user is reproduced therethrough. Therefore, the program icon is not disposed on the screen on which the video is reproduced, which is different from the related art. As a result, interruption of watching the video media may be removed in advance.

Further, the user may immediately watch the wanted video media at any time without having inconvenient of manipulating a file searching program or a video player to access the video media.

The video media list which is reproduced by the video player before entering the initial screen is formed by at least one video medium selected by the user. However, in order to suppress the same video media from being reproduced whenever the status of the mobile terminal 100 is repeatedly switched (from the inactive state to the active state), the video media to be reproduced may be arbitrary video medium among at least one selected video media. As described above, since the video media which are selected by the intention of the user is reproduced, as compared with a technique which reproduces the video media provided from the video media providing server 200, there is no worry of being exposed to reckless advertisement. Since the video media stored in the storing unit 160 is reproduced, there is no issue of expense which may be generated while the streaming video image is reproduced. Further, even though the mobile terminal 100 is not connected to the wireless communication network including the mobile terminal to communicate with each other, the mobile terminal 100 may be normally driven.

In the meantime, when the mobile terminal 100 reproduces the video media before entering the initial screen, a user command for entering the initial screen may be input. The user command may be performed by a touch input on any one area of the screen. That is, when the user wants to quickly stop the video player, the mobile terminal 100 may enter the initial screen by simply touching the screen.

At the time of entering the initial screen, the video player which is played by the mobile terminal 100 ends or is switched to a standby mode. Therefore, the video player which is played according to the present disclosure does not affect several programs which are operated on the initial screen.

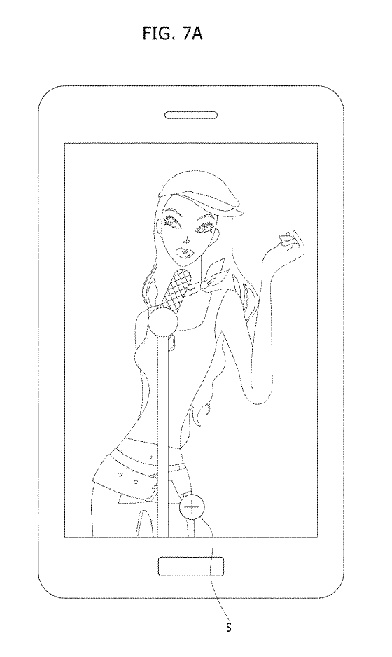

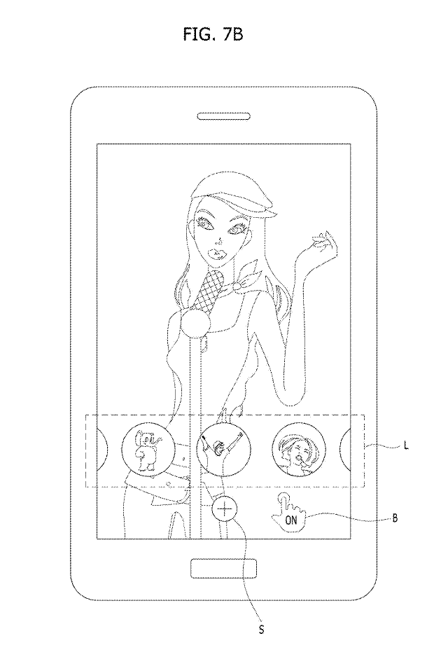

As described above, since the video player ends by simple manipulation, an interface for suppressing a video which is being reproduced and watched from being ended by unintentional touch input, due to an attribute of the video media having a predetermined reproducing time may be desirably provided. Accordingly, as illustrated in FIG. 7B, in order to suppress the mobile terminal from ending the video player which is being played by the touch input to enter the initial screen while reproducing the video media, the mobile terminal 100 may provide an interface such as an initial screen entering prevention icon B. That is, the mobile terminal 100 may set whether to generate a user command to enter the initial screen by a touch input on any one area of the screen through a selection input for the initial screen entering prevention icon B.

In this case, the initial screen entering prevention icon B is output when the video media list is output while reproducing the video media as illustrated in FIG. 7B or output on the screen together with the video media selection icon S for receiving the user command for outputting the video media list.

In the meantime, the mobile terminal 100 which reproduces the video media before entering the initial screen may provide the video media selection icon S for receiving the user command to output the video media list on the screen to the user, as illustrated in FIG. 7A.

That is, in the second step S200, an interface for receiving a selection of a video medium to be currently reproduced from the selected media list or the video media stored in the storing unit 160, without entering the initial screen to play the video player may be provided.

When there is a selection input for the video media selection icon S from the user, as illustrated in FIG. 7B, the mobile terminal 100 enumerates the video media list which is set in advance by the user or the video media list stored in the storing unit 160 to provide the lists to the user. When there is a selection input of the user from the enumerated video media lists, the mobile terminal 100 may immediately reproduce the selected video media.

As described above, an environment for selecting a video medium which is wanted by the user to watch without entering the initial screen, convenience of the user is increased.

As described above, the video medium which is reproduced according to the exemplary embodiment of the present disclosure is an arbitrary video medium of a list formed by video media which are selected by the user. However, according to the exemplary embodiment of the present disclosure, the storing unit 160 stores a weekly video media reproducing list and a video medium to be reproduced by the mobile terminal 100 may be an arbitrary video medium selected from the video media list corresponding to the present day of the week.

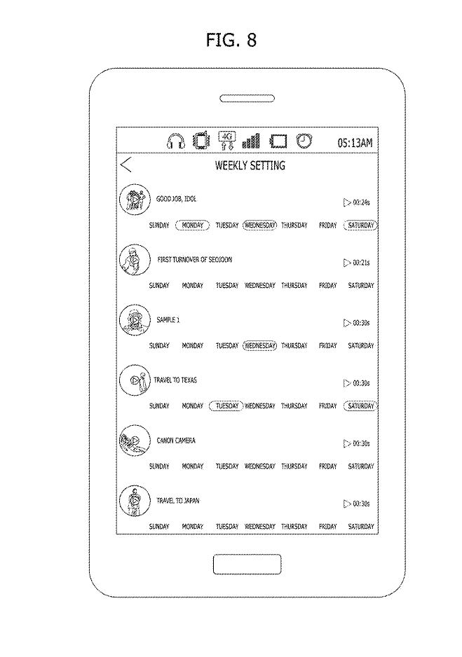

Accordingly, the mobile terminal 100 may receive an input for setting the weekly video media reproducing list from the user. As a specific example thereof, the mobile terminal 100 may provide an interface for setting a video media list to be reproduced every weekday or an interface for selecting a day of the week when any one of video media is reproduced, as illustrated in FIG. 8, to the user, to receive a setting input.

As described above, a video media list to be reproduced every weekday is set and the mobile terminal 100 reproduces the video media of the corresponding day of the week in accordance with the setting so that the user is provided with the customized video media in accordance with the user's preference, so that satisfaction is improved.

In the meantime, according to the exemplary embodiment of the present disclosure, the control method of the mobile terminal 100 may further include a step of receiving information on at least one video medium to be transmitted, the opposite party to which the at least one video medium is transmitted, and a time to transmit the video medium, from the user, a step of transmitting the input information and the video medium based on the input information to a time capsule server 300, a step of transmitting, by the time capsule server 300, an alarm signal to the opposite party when it reaches the time, and a step of transmitting, by the time capsule server 300, the at least one video medium to a terminal of the opposite party in accordance with a request received from the terminal of the opposite party.

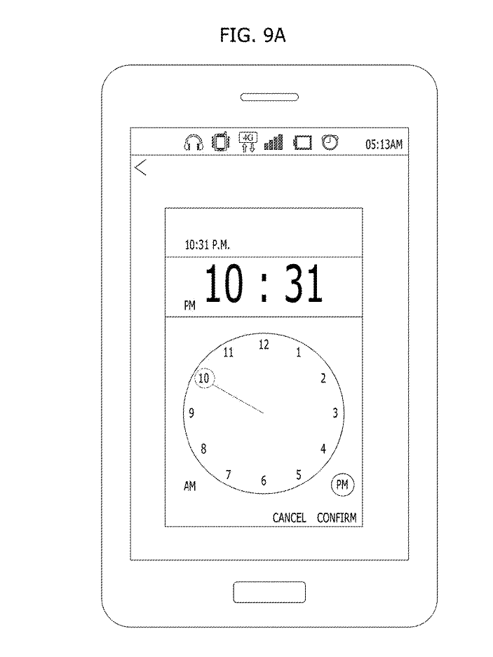

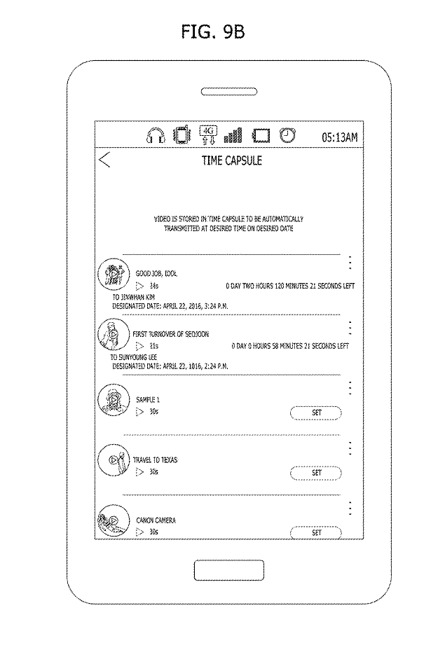

FIGS. 9A and 9B are exemplary views of a screen using a time capsule server according to an exemplary embodiment of the present disclosure.

The user may transmit a video message such as a confession message, a longing message, a birthday message, or a love message to a specific opposite party. Further, in order to transmit the video medium selected at a desired time on a desired date, the mobile terminal 100 may set information of the opposite party (for example, a phone number of the mobile terminal, and the like) to which the video message is transmitted, a time to transmit the video message (see FIG. 9A), and a video media list to be transmitted.

The mobile terminal 100 which is completely set may transmit the video media to the time capsule server 300 together with the information of the opposite party and the time information.

When the current time reaches the set date and time, the time capsule server 300 uses a timer (not illustrated) which calculates the current time to transmit the alarm signal to the corresponding opposite party (specifically, the terminal of the opposite party). When there is a request of transmitting the video media from the terminal of the opposite party, the time capsule server 300 may transmit the video media which are uploaded by the mobile terminal 100 to the terminal of the opposite party in accordance with the request.

Here, the time capsule server 300 transmits the alarm signal instead of the video media so that a terminal of the opposite party in which the video player which is driven before entering the initial screen is not provided plays the transmitted video media. The alarm signal may be a push message or a text message which allows the user who receives the alarm signal to access or download the transmitted video media.

In the meantime, the control method of the mobile terminal 100 according to the exemplary embodiment of the present disclosure may further include a step of providing an interface for editing the video media stored in the storing unit 160.

Specifically, the storing unit 160 may include a first storing unit for storing at least one video medium and a second storing unit for storing at least one sound media and provide an interface for combining the at least one video medium stored in the first storing unit and at least one sound media stored in the second storing unit.

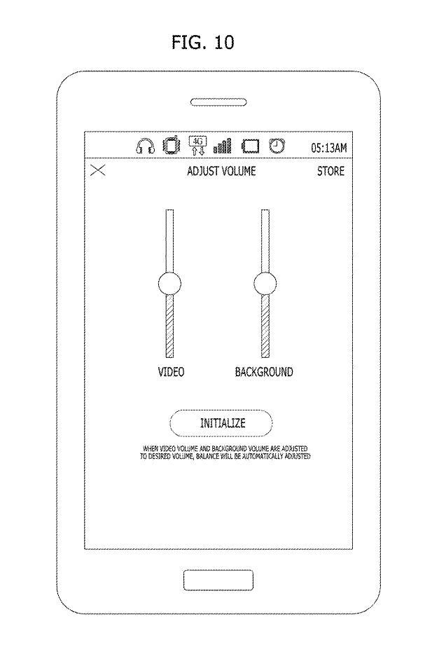

FIG. 10 is an exemplary view of an interface screen which edits a video medium according to an exemplary embodiment of the present disclosure.

For example, as illustrated in FIG. 10, the mobile terminal 100 may provide an interface for receiving a user input to adjust a volume of a sound of the video media selected from the video media which are stored by being photographed by the A/V input unit 120 or stored by being downloaded from the video media providing server 200 and a volume of a sound of the sound media selected from the sound media stored in the storing unit. The mobile terminal 100 combines the video media and the sound media whose volumes are adjusted to a volume set by the user to create a new video media to be stored in the storing unit 160.

The newly created video media is set to be reproduced first when the inactive state is switched into the active state before entering the initial screen, uploaded to the video media providing server 200 to be shared by other users, or uploaded to the time capsule server 300 to be transmitted to a terminal of a specific opposite party at a specific time.

The control method of the mobile terminal 100 according to the exemplary embodiment of the present disclosure may further include a step of determining whether the current time is a predetermined alarm time and a step of reproducing an arbitrary video medium among the at least one predetermined video image to be output on the entire screen when the current time is a predetermined alarm signal time.

Generally, the mobile terminal which has the alarm function outputs a predetermined sound through the sound output unit 152 at an alarm time which is set by the user.

However, when the mobile terminal 100 according to the exemplary embodiment of the present disclosure switches the inactive state into the active state at the alarm time and reproduces the video image which is set in advance by the user before entering the initial screen, attention of the users may be further concentrated to maximize the alarm effect.

### Computer Readable Recording Medium

A method for controlling a mobile terminal according to the exemplary embodiment of the present disclosure described above may be implemented in the form of a program command which may be executed through various computer components to be recorded in a computer readable recording medium.

The computer readable recording medium may include solely a program command, a data file, a data structure, and the like, or a combination thereof. The program commands recorded in the computer readable recording medium may be specifically designed or constructed for the present disclosure or known to those skilled in the art of computer software to be used. Examples of the computer readable recording medium include magnetic media such as a hard disk, a floppy disk, or a magnetic tape, optical recording media such as a CD-ROM or a DVD, magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter. The hardware device may operate as one or more software modules in order to perform the operation of the present disclosure and a reverse thereof is the same.

The exemplary embodiment of the present disclosure has been described in detail with reference to the drawings. The description of the present disclosure is illustrative only and it is understood by those skilled in the art that the present disclosure may be easily modified to another specific type without changing the technical spirit of an essential feature of the present disclosure.

Therefore, the scope of the present disclosure is represented by the claims to be described below rather than the detailed description, and it is to be interpreted that the meaning and scope of the claims and all the changes or modified forms derived from the equivalents thereof come within the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A control method of a mobile terminal, the method comprising:
a first step of storing, by a storing unit, at least one video medium;
a second step of reproducing, by a control unit, an arbitrary video medium among at least one video medium which is previously selected from the stored video media to output the video media on an entire screen before the mobile terminal enters an initial screen by switching an inactive state to an active state and providing an interface for receiving a user command for entering the initial screen; and
a third step of entering, by the control unit, the initial screen in accordance with the user command.

2. The control method according to claim 1, wherein the initial screen is a lock screen which includes an interface for receiving an unlock input or a background screen which includes an interface for receiving a program executing command stored in the storing unit.

3. The control method according to claim 1, wherein the user command for entering the initial screen is performed by a touch input on any one area of the screen, and in the second step, an interface for receiving an input to suppress entering the initial screen by the touch input on any one area of the screen is provided.

4. The control method according to claim 1, wherein in the second step, an interface for receiving a selection input for a video medium which is currently reproduced, from the at least one previously selected video media list or at least one video media list stored in the storing unit without entering the initial screen is provided.

5. The control method according to claim 1, further comprising:
downloading, by the control unit, at least one video medium selected from the video media list which is provided by a video media providing server; and
storing the downloaded video medium in the storing unit.

6. The control method according to claim 5, wherein in the downloading, an arbitrary advertisement in an advertisement list which is provided from an advertisement providing server is output on the screen during the downloading.

7. The control method according to claim 5, further comprising:
uploading, by the control unit, the video media selected by the user, among the video media stored in the storing unit to the video media providing server.

8. The control method according to claim 7, wherein in the uploading, an arbitrary advertisement in an advertisement list which is provided from an advertisement providing server is output on the screen during the uploading.

9. The control method according to claim 1, further comprising:
storing, by the storing unit, previously set weekly video media reproducing lists, wherein in the second step, an arbitrary video medium in a video media reproducing list corresponding to a present day of the week among the weekly video media reproducing lists is reproduced to be output on a screen.

10. The control method according to claim 1, further comprising:
receiving information on at least one video medium to be transmitted, a terminal of an opposite party to which the at least one video medium is transmitted, and a time to transmit the at least one video medium, from the user;
transmitting the information on the terminal of the opposite party to transmit, the time to transmit, and the video media to be transmitted to a time capsule server;
transmitting, by the time capsule server, an alarm signal to the terminal of the opposite party when it is the time to transmit; and
transmitting, by the time capsule server, the at least one video medium to the terminal of the opposite party in accordance with a request received from the terminal of the opposite party.

11. The control method according to claim 1, wherein the storing unit includes a first storing unit which stores the at least one video medium; and a second storing unit which stores at least one sound medium, and
the control method further includes:
providing, by the control unit, an interface for receiving a volume adjusting input for the video medium of the first storing unit and the sound medium of the second storing unit, selected by the user, respectively; and
combining the video medium of the first storing unit and the sound medium of the second storing unit with the volume determined in accordance with the volume adjusting input

12. The control method according to claim 1, further comprising:
determining whether a present time is a previously set alarm time; and
reproducing an arbitrary video medium among at least one previously set video medium when the present time is the previously set alarm time, to be output on the entire screen.

13. A mobile terminal, comprising:
a storing unit which stores at least one video medium; and
a control unit which reproduces an arbitrary video medium among at least one video medium which is previously selected from the stored video media to output the video medium on an entire screen before the mobile terminal enters an initial screen by switching an inactive state to an active state and provides an interface for receiving a user command for entering the initial screen.

14. A system for providing video media, the system comprising;
the mobile terminal according to claim 13; and
a video media providing server which transmits video media to the mobile terminal or receives the video media from the mobile terminal to store video media.

15. A computer readable recording medium which records a computer program to execute the method according to claim 1.
